(19) United States
(12) Patent Application Publication
(10) Pub. No.: US 2009/0146460 A1
(43) Pub. Date: Jun. 11, 2009

(54) ACCESSORY MOUNTING SYSTEM USING SINGLE ACTUATION RELEASABLE CONNECTION DEVICE AND VEHICLE USING SAME

(75) Inventors: Michael E. Caporali, Endicott, NY (US); Jason Christ, (US)

Correspondence Address: BURNS & LEVINSON, LLP, 125 SUMMER STREET, BOSTON, MA, 02110, US

(73) Assignee: LOCKHEED MARTIN CORPORATION, Owego, NY (US)

(21) Appl. No.: 11/950,660

(22) Filed: Dec. 5, 2007

(51) Int. Cl. B60D 1/36

(52) U.S. Cl. 296/193.03

(57) ABSTRACT

An accessory mounting system for a vehicle and a vehicle having same, provides a receiver adapted for mounting to a vehicle chassis and including a multiplicity of receptacles; an accessory mounting element adapted to be affixed to a vehicle accessory and including a multiplicity of securing members each adapted to penetrate a separate one of said multiplicity of receptacles; a slidable device slidably engaged with said receiver and adapted to engage said multiplicity of securing members within the multiplicity of receptacles to provide attachment of the accessory mounting element to the vehicle chassis; and an actuator operably connected to said slidable device and adapted to engage and disengage said slidable device with said multiplicity of securing members with a single actuation.

### STATEMENT REGARDING FEDERALLY SPONSORED RESEARCH OR DEVELOPMENT

This invention was made in part with U.S. Government support from the US Army under Contract No. W56HZV-05-9-002. The U.S. Government has certain rights in the invention.

### FIELD OF THE INVENTION

The present invention is related generally to the field of attaching utility accessories to vehicles. More particularly, the present invention is related to an attachment system using a single actuator for securing a multi-point mount accessory mount to a vehicle.

### BACKGROUND OF THE INVENTION

Conventional three-point hitches have been used for many years on tractors and other vehicles. Three-point hitches can be removably engaged to numerous implements such as plows, seeders, hay bale movers and various other implements. Typically, three-point hitches utilize a relatively complex connecting structure for receiving and securing the hitch to an implement. Thus, connecting and operating conventional three-point hitches can be unduly time consuming, overly cumbersome, and can require significant amounts of labor. While prior devices may be suitable for one particular purpose, they are not suitable for easily and conveniently receiving and securing the hitch of multiple implements to a three-point hitch.

### SUMMARY OF THE INVENTION

In one embodiment, an accessory mounting system for a vehicle, comprises: a receiver adapted for mounting to a vehicle chassis and including a multiplicity of receptacles; an accessory mounting element adapted to be affixed to a vehicle accessory and including a multiplicity of securing members each adapted to penetrate a separate one of said multiplicity of receptacles; a slidable device slidably engaged with said receiver and adapted to engage said multiplicity of securing members within the multiplicity of receptacles to provide attachment of the accessory mounting element to the vehicle chassis; and an actuator operably connected to said slidable device and adapted to engage and disengage said slidable device with said multiplicity of securing members with a single actuation.

The multiplicity of securing members may include a primary securing member and a pair of secondary securing members spaced laterally on either side of the primary securing member, and said slidable device may include a primary bar attached to the actuator and adapted to engage the primary securing member with the single actuation by passing through an opening in the primary securing member when said primary securing member is located in a respective one of said multiplicity of receptacles. The slidable device may further include a pair of secondary bars each adapted to engage a separate one of the pair of secondary securing members with the single actuation by passing through respective openings located therein. The secondary bars may be linked to move with the primary bar. The primary bar may be adapted to slide substantially horizontally at a first vertical height, and further wherein the secondary bars are adapted to slide substantially horizontally at a different second vertical level.

The actuator may be adapted to secure said slidable device in an engaged position and a disengaged position. The actuator may be adapted to extend through a body member of a vehicle for external actuation of said slidable device from outside of the vehicle. The receiver may forms a recess adapted to hold said accessory mounting element in a body member of a vehicle. The actuator may be mechanical, pneumatic, hydraulic, electric, or a combination thereof.

Another embodiment of the present invention provides a ground transportation vehicle having an accessory mounting system, comprising: a receiver mounted to a chassis of the vehicle and including a multiplicity of receptacles; an accessory mounting element adapted to be affixed to a vehicle accessory and including a multiplicity of securing members each adapted to penetrate a separate one of said multiplicity of receptacles; a slidable device slidably engaged with said receiver and adapted to engage said multiplicity of securing members within the multiplicity of receptacles to provide attachment of the accessory mounting element to the vehicle chassis; and an actuator operably connected to said slidable device and adapted to engage and disengage said slidable device with said multiplicity of securing members with a single actuation.

The vehicle may further comprise: a second receiver mounted to the chassis of the vehicle and including a second multiplicity of receptacles adapted to receive said multiplicity of securing members; a second slidable device slidably engaged with said second receiver and adapted to engage said multiplicity of securing members within the second multiplicity of receptacles to provide attachment of the accessory mounting element to the vehicle chassis; and a second actuator operably connected to said second slidable device and adapted to engage and disengage said second slidable device with said multiplicity of securing members with a single actuation.

The vehicle may be a tactical military vehicle. The first said receiver and said second receiver may be located at opposing ends of the vehicle to allow said accessory mounting elements to be selectively mounted to either opposing end of the vehicle.

For a better understanding of the present invention reference is made to the accompanying drawings and detailed description.

### BRIEF DESCRIPTION OF THE DRAWINGS

The present invention is illustratively shown and described in reference to the accompanying drawings, in which:

FIG. 1A is a pictorial view of a securing mechanism constructed in accordance with an embodiment of the present invention and located in an open or disengaged position.

FIG. 1B is a pictorial view of the securing mechanism of FIG. 1A located in a fully engaged position;

FIGS. 2A and 2B are pictorial views of accessory securing systems constructed in accordance with embodiments of the present invention and having alternative actuation embodiments of the locking mechanism;

FIG. 3A is a pictorial view oriented from an overhead position looking down upon an embodiment of the present invention, illustrating a three-point accessory mounting element and a aligned for coupling to a receiver;

FIG. 3B is a pictorial view oriented from underneath the apparatus of FIG. 3A looking up, illustrating the three point accessory mounting elements and the receiver aligned for coupling;

FIG. 4 is a pictorial view of one embodiment of the present invention including a receiver integrated into a chassis of a vehicle;

FIGS. 5A-C are closer views of the embodiment of FIG. 4 showing in phantom an embodiment of the securing mechanism in various operating positions. FIG. 5A shows the securing mechanism fully disengaged. FIG. 5B shows the securing mechanism partially engaged. FIG. 5C shows the securing mechanism fully engaged; and

FIG. 6 is a pictorial view of and accessory mounting element constructed for use with the present invention.

### DETAILED DESCRIPTION OF THE INVENTION

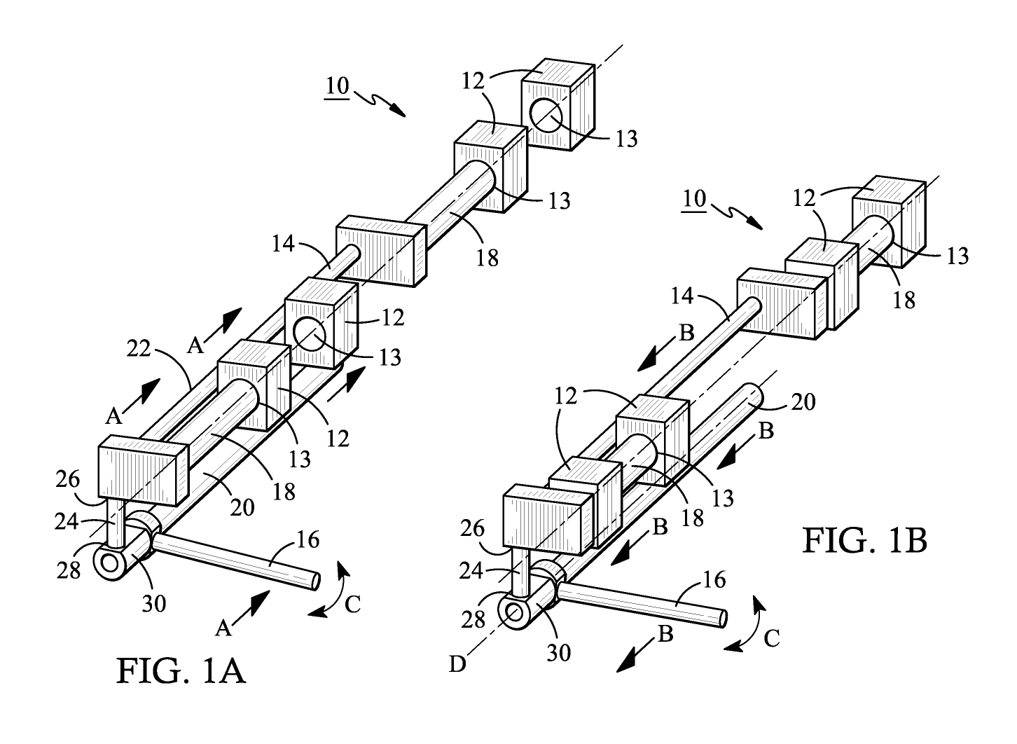

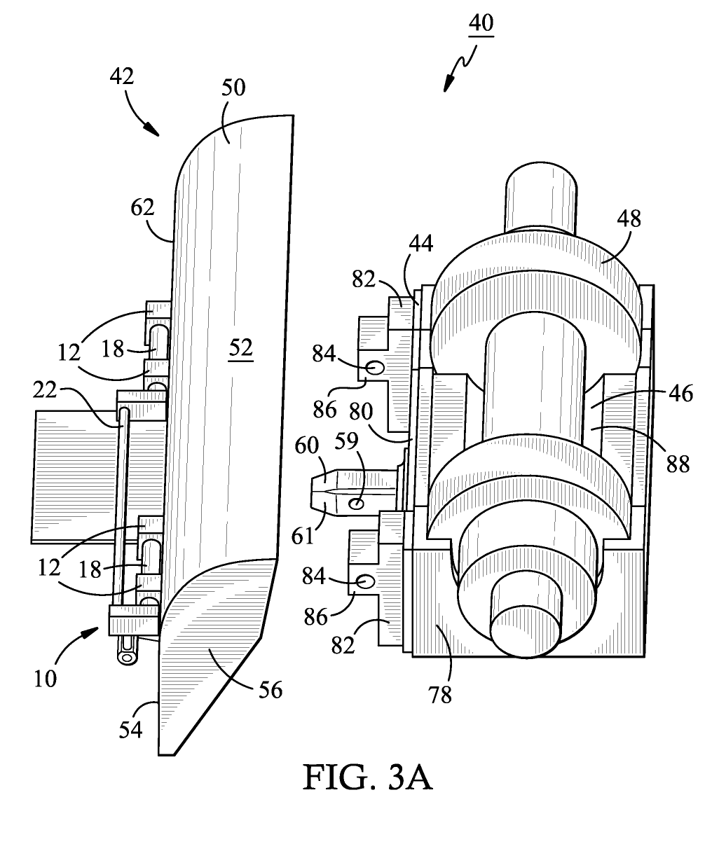

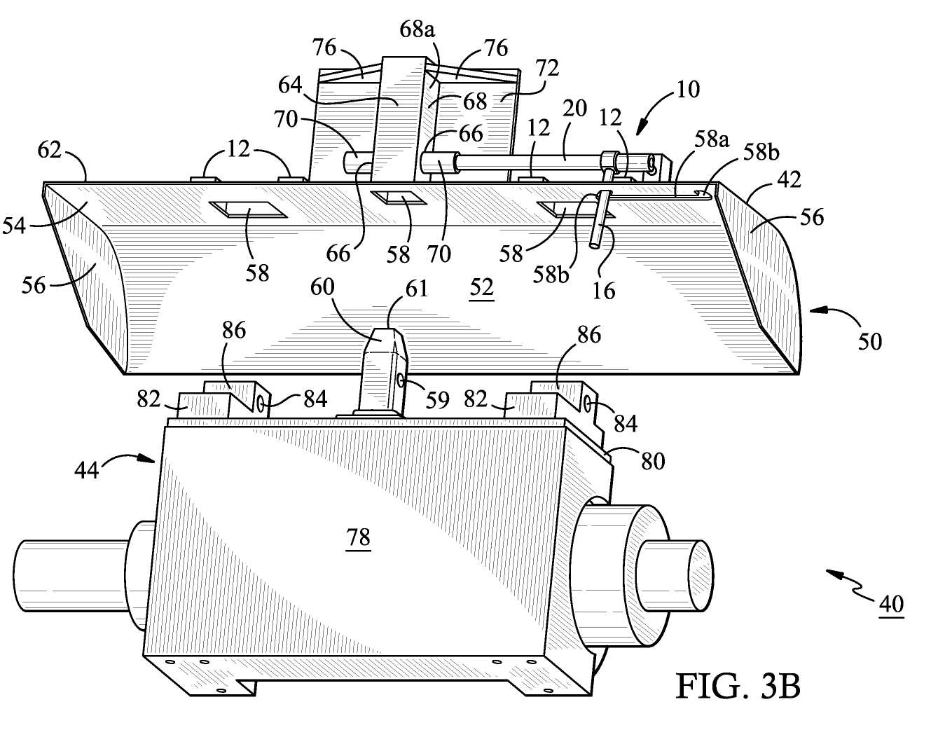

The present invention is a single actuation securing mechanism 10 adaptable to any structure including a vehicle. FIGS. 1A and 1B illustrate securing mechanism 10 of the present invention in a disengaged (or open) position and an engaged (or closed) position, respectively. Securing mechanism 10 is shown in FIGS. 1A and 1B separate from a vehicle to better understand the key components and operation of securing mechanism 10. Locking bar receivers 12 are typically attached to a frame 50 or other structure of the vehicle (See FIGS. 3A, 3B). securing mechanism 10 can include a sliding device 14 and an actuator, for example, a mechanical handle 16. Sliding device 14 can include several individual complementary components arranged together, grouped, or otherwise interconnected such that longitudinal bars 18, 20 are operably connected (discussed in detail below). Longitudinal bars 18, 20 move in concert into locking bar receivers 12, as handle 16 moves transversely in a direction parallel (see arrow A) to the centerline of locking mechanism 10, thereby disengaging (FIG. 1A) or engaging (FIG. 1B, see arrow B) locking mechanism 10 to a vehicle, for example, without the use of biasing means, such as springs, to overcome forces, such as friction or back pressure of pneumatic pistons. One embodiment of a locking bar receiver 12 can be a substantially cubic block of suitable material having a hole 13 bored there through. Like reference numerals designate like parts and assemblies throughout the several views.

As shown in FIGS. 1A and 1B, handle 16 can be pivotally connected to locking bar 20 such that handle 16 can freely pivot orthogonal (see arrow C) to the center line axis of bar 20. However, handle 16 is restrained from moving transversely along bar 20. Handle 16 and bar 20 are operably connected relative to transverse movement. Since bar 20 is operably connected to bars 18, handle 16 is also operably connected to bars 18. Therefore, as handle 16 moves transversely, bars 18, 20 also move transversely.

Since handle 16 is freely slidable in the transverse direction, there must be a mechanism to secure it at one or more predetermined transverse locations such that the locking mechanism 10 remains engaged or disengaged during vehicle operation. One embodiment of the securing mechanism can be a locking handle cutout 58a in frame 50 (shown in FIG. 3B) configured in a “U” shape having end slots 58b to provide a transverse stopping function and/or locking function for securing handle 16 in place once locking handle 16 is either fully disengaged (FIG. 1A) or engaged (FIG. 1B). FIG. 3B shows locking mechanism 10 in an engaged position with handle 16 set in an end slot 58B.

Another embodiment of sliding device 14 may include an integral handle 16 wherein securing mechanism 10 also includes a latch or other means to restrain handle 16 from moving transversely. A latch (not shown) can be attached to the vehicle 100.

Alternative embodiments of handle 16 can be pivotally connected to any component of sliding device 16 depending on the configuration of the vehicle 100 for convenience and ease of actuation by the user. Herein, handle 16 will be described as being pivotally connected to bar 20 for illustration purposes, but it is not intended to limit handle 16 to the described configuration.

Now returning to FIGS. 1A and 1B, sliding device 16 preferably includes two co-axial longitudinal bars 18 disposed above and generally parallel to a single longitudinal bar 20. The set of bars 18, 20 are generally perpendicular to the vehicle longitudinal axis (not shown). Co-axial longitudinal bars 18 are operably connected to each other by a general “U” shaped connector 22 attached to one end of each co-axial longitudinal bar 18. Further, “U” shaped connector 22 includes an extension 24 orthogonally connected at one of its ends 26 to one end of “U” shaped connector 22. Extension 24 extends downward and generally perpendicular to “U” shaped connector 22. The other end 28 of extension 24 is connected to single longitudinal bar 20. Extension 24 can be orthogonally connected to single longitudinal bar 20 by any conventional joining means. An example of a means to join extension 24 to single longitudinal bar 20 is connector 30. Connector 30 can be a ring sized to frictionally engage single longitudinal bar 20. Alternative joining means include a lock screw, welding, brazing, or soldering. Extension 24 can be connected to connector 30 by conventional joining means. As discussed above, locking handle 16 is connected to single longitudinal bar 20. The connection, arrangement, or assembly of co-axial longitudinal bars 18, single longitudinal bar 20, and handle 16 into a group or gang by way of the “U” shaped connector 22 provides for simultaneous operation of bars 18, 20 with a single actuation of handle 16.

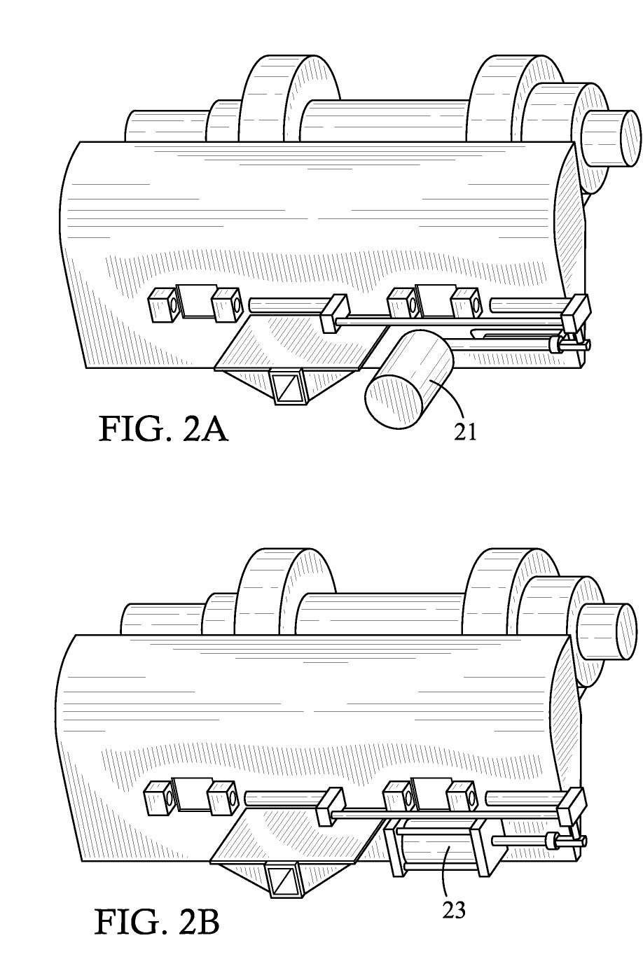

Alternative embodiments of securing mechanism 10 can replace the mechanical handle 16 with an electric motor actuation 21 (FIG. 2A) or pneumatic/hydraulic actuation 23 (FIG. 2B).

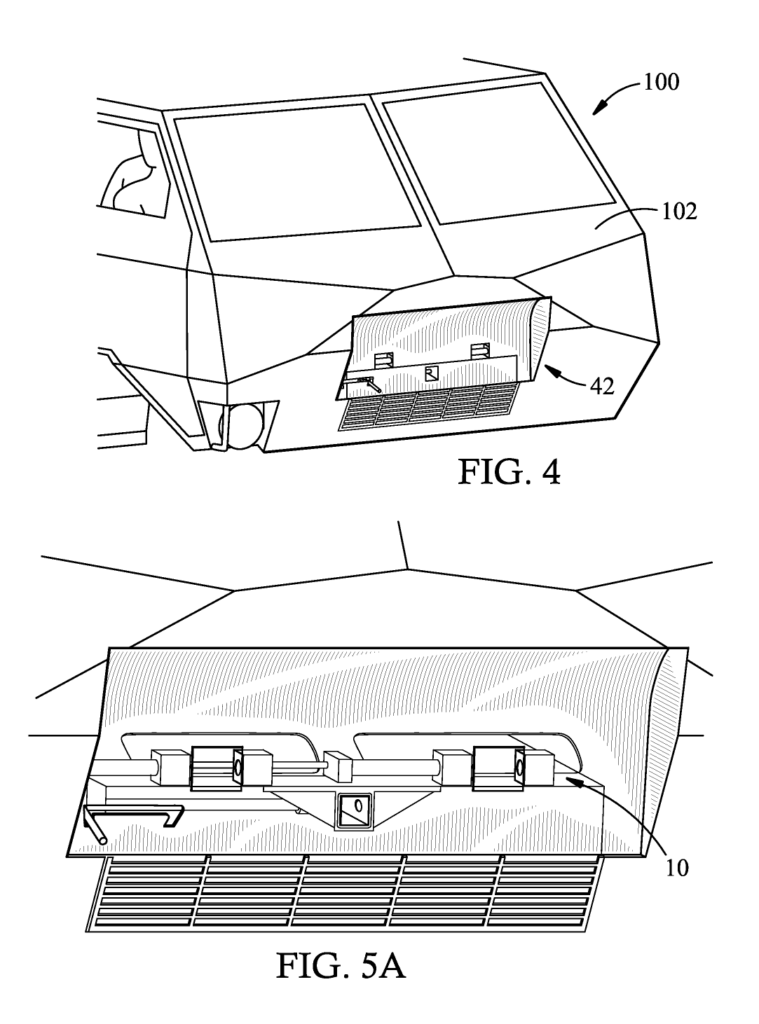

Securing mechanism 10 can be adapted for use with an apparatus system 40, illustrated in FIGS. 3A and 3B. Apparatus system 40 includes a receiver 42 and an apparatus mount 44. Receiver 42 can be integrated into and mounted to the front end, rear end, or both ends of vehicle 100 (FIG. 4). Apparatus mount 44 can include an apparatus holder 46 to secure or support an apparatus 48, such as a winch, to apparatus mount 44. In operation, apparatus mount 44 is interconnected to receiver 42 by securing mechanism 10 (as described below), thereby operably connecting apparatus 48 to vehicle 100.

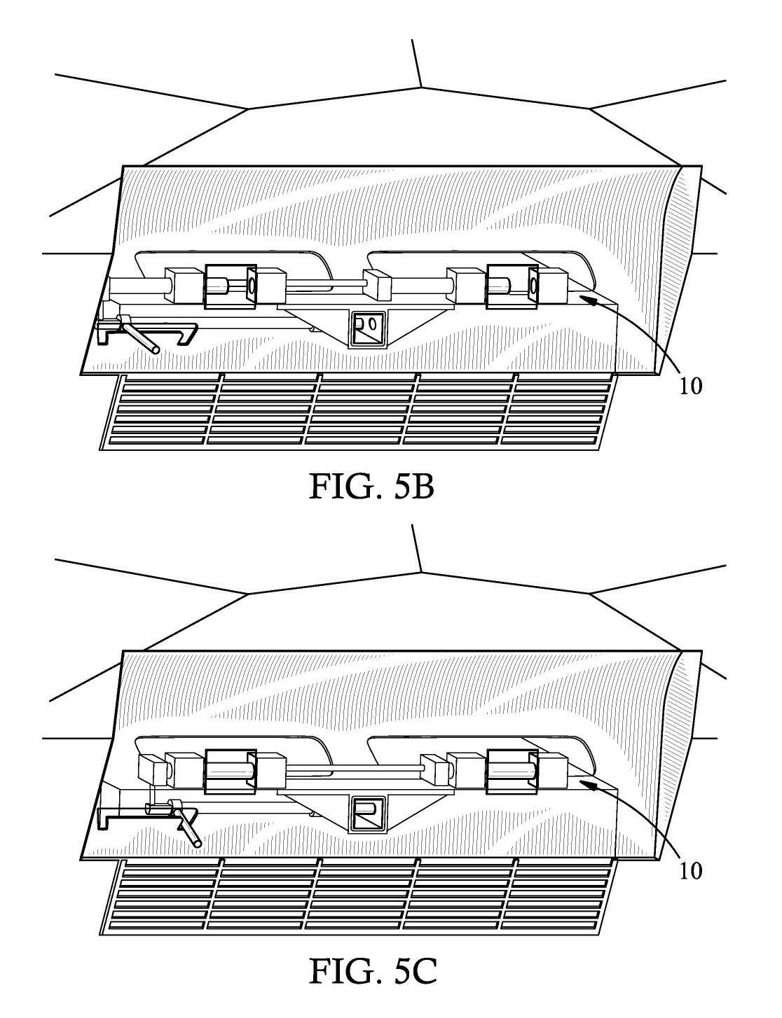

Referring to FIG. 4, vehicle 100 is illustrated with a receiver 42 integrated into the front end 102 thereof. Vehicle 100 can be any vehicle with receiver 42 being fitted into the front end 102 and/or the rear end (not shown) of vehicle 100. FIG. 5A shows securing mechanism 10 fully disengaged. FIG. 5B shows securing mechanism 10 partially engaged. FIG. 5C shows securing mechanism 10 fully engaged. Therefore, the description of assembly or attachment of receiver 42 to vehicle 100 will be applicable to either attachment location.

Now returning to FIGS. 3A and 3B, receiver 42 includes a frame 50 being generally shaded like a plow shovel (but any suitable configuration is acceptable) having a curved upper portion 52 transitioning to a substantially straight back plate 54 with two side plates 56. Back plate 54 includes a cutout 58a configured to receive handle 16 of securing mechanism 10 (discussed in detail above). Cutout 58a also acts as a transverse motion guide and handle 16 locking mechanism with notches 58b at either end of cutoff 58a to transversely receive handle 16.

Attached to back side 62 of back plate 54 can be one or more pairs of locking bar receivers 12. The present embodiment illustrates two pairs of locking bar receivers 12. However, the present embodiment is not to be limited by the illustration of two pairs of locking bar receivers 12. Locking bar receivers 12 can be attached to back plate 54 by any conventional attachment means, such as, but not to be limited to, welding, brazing, soldering, adhering, screws, and nuts/bolts. Each block of the pair of locking bar receivers 12 can be positioned longitudinally on opposing sides of holes 58. Locking bar receivers 12 are oriented such that the hole center lines of each hole 13 are aligned along the same or common axis (see FIG. 1A). The common axis is substantially orthogonal with the vehicle's longitudinal axis. For example, the vehicle's longitudinal axis can traverse from the front-to-rear of the vehicle at a substantially equal height above the ground or road surface. The vehicle's latitudinal axis can traverse from the left side-to-right side of the vehicle at a substantially equal height above the ground or road surface. Locking bars 18 also have a longitudinal axis substantially coaxial with the hole common axis of hole 13 facilitating a smooth translation of locking bars 18 through each hole 13. Locking bars 18, 20 are configured slightly smaller outer diameter than hole 13 and hole 59 to facilitate a snug fit while maintaining ease of engagement and disengagement.

Returning to FIG. 3B and a further description of receiver 42, receiver 64 is generally a rectangular or square shaped socket attached to a horizontal or vertical lower frame member (not shown) of vehicle 100. Receiver 64 includes two co-axial holes 66 on opposing sides 68 of receiver 64. Two sleeves 70 are co-axially aligned with holes 66 and attached to the outer surface 68a of sides 68. Sleeves 70 act as guides for bar 20 into holes 66, and also act as load distributors as bar 20 displaces from side-to-side and up-and-down during vehicle operation and contacts the inner surface (not shown) of sleeves 70 and edges of holes 66. Alternatively, receiver plate 72 is connected to receiver 64 along its top surface (not shown) to provide a larger area for attachment to vehicle 100. A further alternative embodiment includes support plates 76 connecting to and extending downward perpendicular from receiver plate 72 to receiver 64. Support plates 76 provide for additional roll or torsional stability. It is contemplated that the receiver 64 and correspondingly sized and shaped coupler 60 can be any selected size and shape. In the exemplary embodiment, receiver 64 is located on vehicle 100 at an elevation thereon lower than where locking bar receivers 12 are located on vehicle 100.

Frame 50 and its subcomponents can be made from any suitable material, such as sheet metal, steel, composite, aluminum, and any other metal or polymer or combination thereof, that can adequately withstand the operational load stresses of securing apparatus mount 44 and apparatus 48 to vehicle 100 during operation.

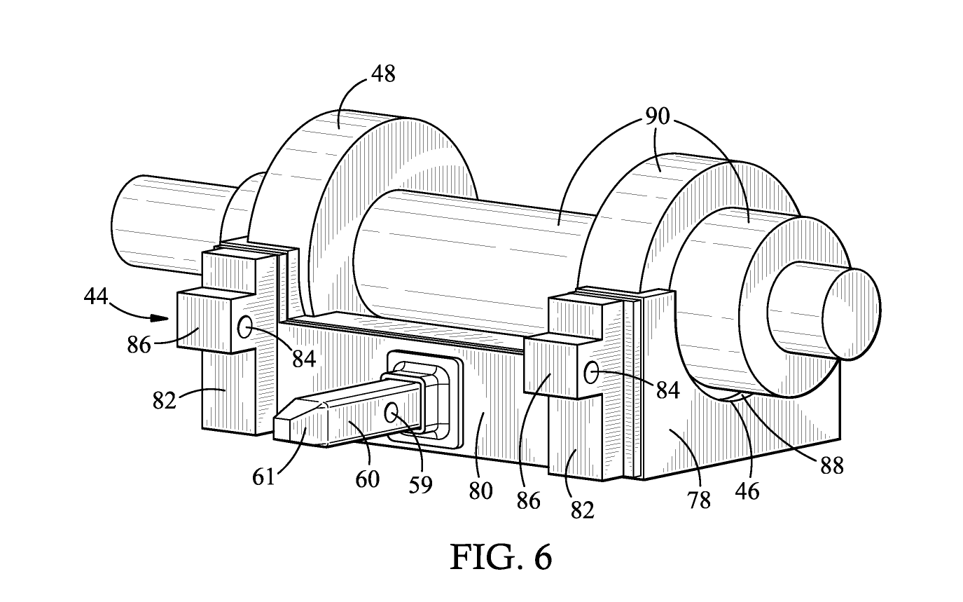

FIG. 6 depicts apparatus mount 44 with apparatus 48 contained therein. Apparatus mount 44 can include a base 78 having two apparatus mount receivers 82 and a coupler 60 mounted to front surface 80 of base 78 and generally parallel to the vehicle longitudinal axis (for example, front to rear orientation) when assembled to vehicle 100. Coupler 60 is a substantially straight member extending outwardly and orthogonally from front surface 80 of base 78. Coupler 60 has a tapered end 61 to aid in the insertion of coupler 60 into receiver 64 and a hole 59 there through having a centerline substantially parallel with the centerline of extension holes 84. In the exemplary embodiment, coupler 60 is located on apparatus mount 44 at an elevation thereon lower than where apparatus mount receivers 82 are located on apparatus mount 44. Further, coupler 60 and apparatus mount receivers 82 must be oriented with respect to each other similar to their counterparts of receiver 42 (receiver 64 and locking bar receivers 12, respectively) for appropriate cooperation therewith. Though a pair of apparatus mount receivers 82 are illustrated, it is within the contemplation of the present invention that as few as one apparatus mount receiver is sufficient to cooperate with only one pair of locking bar receivers 12 to interconnect receiver 42 with apparatus mount 44.

Apparatus mount receivers 82 can be generally “T” shaped having extensions 86, which are of a similar configuration as locking bar receivers 12. Extensions 86 are sized to fit within locking bar receiver 12. One embodiment of an apparatus mount receiver extensions 86 can be, for example, a substantially cubic block of suitable material having a hole 84 bored there through. Apparatus mount receivers 82 can be attached to front surface 80 of base 78 by any conventional attachment means, such as, but not to be limited to, welding, brazing, soldering, adhering, nuts/bolts, and screws (as shown in FIG. 6). Where two apparatus mount receivers 82 are attached to apparatus mount 44, apparatus mount receivers 82 are oriented such that the hole center lines of each hole 84 are aligned along the same centerline axis. This hole common centerline axis is substantially the same as the hole common axis of locking bar receiver holes 13 when apparatus mount 44 is assembled to tow receiver 42.

In operation, apparatus mount locking bar receivers 82 and coupler 60 are inserted into holes 58 of receiver 42. Receiver extensions 86 are disposed between locking bar receivers 12 such that holes 84 align with holes 13. Coupler 60 is inserted into receiver 64 and positioned such that hole 59 of coupler 60 is disposed between and aligned with holes 66 of receiver 64. Locking mechanism 10 (discussed in detail above) slidably actuates bar 18 to engage the two pairs of locking bar receivers 12 with the apparatus mount locking bar receivers 82. Simultaneously, bar 20 moves transversely to be received into sleeve 70, which guides bar 20 through holes 66 of receiver 64. Bar 20 continues through hole 59 of coupler 60, opposing holes 66 of receiver 64, and into opposing sleeve 70. Therefore, receiver 64 and locking bar receivers 12 are cooperatively engaged with coupler 60 and apparatus mount receivers 82, respectively, to provide a three point connection of apparatus mount 44 to receiver 42, and therefore to vehicle 100.

One embodiment of the simultaneous operation may include the bars 18, 20 entering holes 84, 59 at substantially the same time.

Now returning to FIG. 6, apparatus mount 44 further includes an apparatus holder 46. Apparatus holder 46 can be a recess or cavity 88 sufficiently sized and configured to receive an apparatus 48. For illustration purpose only, the apparatus shown in the figures and described herein is a winch. However, apparatus mount 44 and recess 88 can be configured to hold any apparatus. One embodiment of recess 88 is semi-circular and is complimentary to the outer surfaces 90 of winch 48, such as surface protrusions or projections, to assure stability and limit movement of winch 48 during operation and transportation.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

What is claimed is:

1. An accessory mounting system for a vehicle, comprising:
a receiver adapted for mounting to a vehicle chassis and including a multiplicity of receptacles;
an accessory mounting element adapted to be affixed to a vehicle accessory and including a multiplicity of securing members each adapted to penetrate a separate one of said multiplicity of receptacles;
a slidable device slidably engaged with said receiver and adapted to engage said multiplicity of securing members within the multiplicity of receptacles to provide attachment of the accessory mounting element to the vehicle chassis; and
an actuator operably connected to said slidable device and adapted to engage and disengage said slidable device with said multiplicity of securing members with a single actuation.

2. The system according to claim 1, wherein said multiplicity of securing members includes a primary securing member and a pair of secondary securing members spaced laterally on either side of the primary securing member, and further wherein said slidable device includes a primary bar attached to the actuator and adapted to engage the primary securing member with the single actuation by passing through an opening in the primary securing member when said primary securing member is located in a respective one of said multiplicity of receptacles.

3. The system according to claim 2, wherein said slidable device further includes a pair of secondary bars each adapted to engage a separate one of the pair of secondary securing members with the single actuation by passing through respective openings located therein.

4. The system of claim 3, wherein the secondary bars are linked to move with the primary bar.

5. The system of claim 4, wherein the primary bar is adapted to slide substantially horizontally at a first vertical height, and further wherein the secondary bars are adapted to slide substantially horizontally at a different second vertical level.

6. The system according to claim 1, wherein said actuator is adapted to secure said slidable device in an engaged position and a disengaged position.

7. The system according to claim 1, wherein said actuator is adapted to extend through a body member of a vehicle for external actuation of said slidable device from outside of the vehicle.

8. The system according to claim 1, wherein said receiver forms a recess adapted to hold said accessory mounting element in a body member of a vehicle.

9. The system according to claim 1, wherein said actuator is mechanical, pneumatic, hydraulic, electric, or a combination thereof.

10. A ground transportation vehicle having an accessory mounting system, comprising:
a receiver mounted to a chassis of the vehicle and including a multiplicity of receptacles;
an accessory mounting element adapted to be affixed to a vehicle accessory and including a multiplicity of securing members each adapted to penetrate a separate one of said multiplicity of receptacles;
a slidable device slidably engaged with said receiver and adapted to engage said multiplicity of securing members within the multiplicity of receptacles to provide attachment of the accessory mounting element to the vehicle chassis; and
an actuator operably connected to said slidable device and adapted to engage and disengage said slidable device with said multiplicity of securing members with a single actuation.

11. The vehicle of claim 10, further comprising:
a second receiver mounted to the chassis of the vehicle and including a second multiplicity of receptacles adapted to receive said multiplicity of securing members;
a second slidable device slidably engaged with said second receiver and adapted to engage said multiplicity of securing members within the second multiplicity of receptacles to provide attachment of the accessory mounting element to the vehicle chassis; and
a second actuator operably connected to said second slidable device and adapted to engage and disengage said second slidable device with said multiplicity of securing members with a single actuation.

12. The vehicle of claim 11, wherein the vehicle is a tactical military vehicle.

13. The vehicle of claim 11, wherein the first said receiver and said second receiver are located at opposing ends of the vehicle to allow said accessory mounting elements to be selectively mounted to either opposing end of the vehicle.
